(19) United States
(12) Patent Application Publication
(10) Pub. No.: US 2026/0039183 A1
(43) Pub. Date: Feb. 5, 2026

(54) SYSTEMS AND METHODS FOR SELF-SYNCHRONIZING POLY-PHASE ELECTRICAL DEVICES

(71) Applicant: Renew Power Systems Inc., Minneapolis, MN (US)

(72) Inventors: Gregory S. Mowry, Burnsville, MN (US); Daniel J. O’Connor, Minneapolis, MN (US); Zachary J. Emond, Lakeville, MN (US)

(73) Assignee: Renew Power Systems Inc., Minneapolis, MN (US)

(21) Appl. No.: 19/288,734

(22) Filed: Aug. 1, 2025

Related U.S. Application Data
(60) Provisional application No. 63/678,872, filed on Aug. 2, 2024.

(51) Int. Cl. H02M 1/00; H02J 3/38; H02M 7/48

(52) U.S. Cl. CPC H02M 1/0067; H02J 3/38; H02M 1/0043; H02M 7/48

(57) ABSTRACT

Systems and devices are disclosed that provide for stackable electrical power systems that provide poly-phase alternating current electricity output. Each electrical power system can be configured with a synchronizer to communicate with at least one other synchronizer, whereby each of the communicating synchronizers becomes synchronized. The synchronizers enable stacking a plurality of electrical power systems without creating feedback, circuit noise, or other drawbacks of the currently existing technology, thus enabling stacking to greater degrees and in more configurations than presently possible.

### RELATED APPLICATIONS

This application claims the benefit of priority under 35 U.S.C. § 119(e) to U.S. Provisional Patent Application 63/678,872, titled “SYSTEMS AND METHODS FOR SELF-SYNCHRONIZING POLY-PHASE ELECTRICAL DEVICES,” filed Aug. 2, 2024, which is hereby incorporated herein by reference in its entirety for all purposes.

### TECHNICAL FIELD

The present disclosure relates generally to self-synchronizing electrical devices, and more particularly to self-synchronizing poly-phase drivers and inverters.

### BACKGROUND

Electricity is generated, regulated and delivered to a point of consumption—a load—but rarely with the particular characteristics needed at the load. Electricity provisioned by an electrical grid generally is three-phase, and of a high voltage. Three-phase power generation and applications are a world standard. Three-phase machines are a bedrock of industrial nations. For use at the load, three-phase electricity may need to be adjusted to a lower voltage, or to single-phase, or to two-phase, etc. When locally generated, electricity may be output from the generator as direct current (DC) and converted for use in an alternating current (AC) system. Or the generator may provide AC electricity, but at a voltage that does not match the load requirements. At least as likely as the foregoing scenarios is the situation that multiple loads of differing characteristics exist at the same site. By way of example, a single-family residence in the United States typically has numerous devices that use one-phase electricity at a nominal 120V (˜110V-120 V) and at least one device that uses one-phase electricity at 240V (˜210V to 260V). For commercial and industrial sites, these variations in characteristics may be higher in number and greater in breadth. The current state of the art employs a relatively complex system of components to reconfigure electricity as needed for the particular application. Furthermore, this complex reconfiguring system is limited in the number of components that can be combined (e.g., “stacked”) and, hence, is limited in its capacity to reconfigure the electricity.

### SUMMARY

The present disclosure describes means for rapidly and reliably adjusting electricity characteristics, such as voltage, phase (phase angle and/or number of phases), frequency, etc. with simpler and fewer components than is available in the art today. Furthermore, the systems and methods described herein provide for component compounding (e.g., stacking) while avoiding circuit noise, feedback, etc., that arise when attempting to stack currently available technologies, and obviate the limitations imposed to avoid the disadvantages of the current state of the art.

Additional aspects and advantages will be apparent from the following detailed description of preferred embodiments, which proceeds with reference to the accompanying drawings.

### BRIEF DESCRIPTION OF THE DRAWINGS

FIG. 1A is a block diagram of a self-synchronizing power system (“SPS”), according to an embodiment of the present disclosure.

FIG. 1B is a block diagram of an SPS, according to an embodiment of the present disclosure, and comprising a plurality of 1-phase self-synchronizing power systems (“_{P}SPSs”).

FIG. 1C is a block diagram of an SPS, according to another embodiment of the present disclosure, and comprising a plurality of _{P}SPSs.

FIG. 2 is a block diagram of an SPS, according to an embodiment of the present disclosure, and comprising a plurality of 1-phase self-synchronizing power systems (“_{P}SPSs”).

FIG. 3A is a diagram of a stacked SPS comprising stackable SPS (“stacked SPS”), according to an embodiment of the present disclosure.

FIG. 3B is a diagram of a stacked SPS, according to another embodiment of the present disclosure, wherein the stacked SPS is a poly-phase SPS (“_{PP}SPS”).

FIG. 4 is a diagram of a stacked SPS, according to an embodiment of the present disclosure, and comprising a 3-phase power system and a 3-phase load.

FIG. 5 is a chronometric plot of voltages taken from a built embodiment of the stackable SPS of FIG. 4.

FIG. 6 is a spectral response graph for voltages of the v2-y nodes of first, second, and third non-linear subsystem controls (“NSCs”) of the _{P}SPSs embodiment built of the stackable SPS of FIG. 4, both before and after synchronization.

FIG. 7 is a comparative voltage plot for the post-synchronization voltages at a v2-y node and a v1-x node of an NSC in a built embodiment of the stackable SPS of FIG. 4.

FIG. 8 is a circuit diagram of a non-linear circuit of a synchronization unit, according to an embodiment of the present disclosure.

FIG. 9 is a circuit diagram of an example circuit of a synchronization unit to implement or otherwise provide a non-linear characteristic or chaotic characteristic for the synchronization unit.

### DETAILED DESCRIPTION OF PREFERRED EMBODIMENTS

The embodiments disclosed herein provide systems and methods to alter at least the voltage, the phase angle, the number of phases, and the frequency of electricity. Furthermore, the embodiments permit stacking the components such that greater variation can be achieved than is possible with existent technology. The present disclosure describes means for rapidly and reliably adjusting electricity characteristics, such as voltage, phase (phase angle and/or number of phases), frequency, etc. with simpler and fewer components than is available in the art today.

The present disclosure includes and/or extends the self-synchronizing technology, such as synchronization units (e.g., synchronization circuitry (e.g., hardware), synchronization modules (e.g., software)) (hereafter, “synchronizer,” “synchronizers”), described in U.S. patent application Ser. No. 17/648,089 entitled SELF-SYNCHRONIZING DEVICES, SYSTEMS, AND METHODS, filed Jan. 14, 2022, and issued Oct. 15, 2024 as U.S. Pat. No. 12,119,660, hereafter referenced as “the '660 patent,” which is incorporated herein by reference in its entirety.

As used herein, “coupled” refers to a physical or electrical connection between two or more components. A physical connection may comprise two or more components physically touching or being in proximity to each other, or being interconnected as by another component. An electrical connection is any connection whereby electricity or an electrical signal is permitted or caused to flow from one component to at least one other component.

As used herein, the term “common” has its standard linguistic meaning of unity, and does not necessarily carry the meaning applied in the sphere of electricity.

As used herein, the term 1-phase refers to a characteristic of electricity known in the field as 1-phase, single phase, or one phase. Similarly, polyphase electricity is referred to herein as polyphase or by a numeral followed by “-phase,” such as, e.g., 2-phase, 3-phase, etc. Furthermore, reference is made herein to n-phase (or k-phase), meaning the referenced electricity may have an unspecified number of phases.

The self-synchronizing capability referenced herein can be implemented in or by a self-synchronizing device, which can be any electrical device having or including a self-synchronizing capability. The self-synchronizing capability can be embodied as a synchronizer (e.g., a self-synchronizing driver, a self-synchronizing inverter), which can also be referred to herein as a synchronizing circuit or synchronizing unit. Examples of a synchronizer can include or employ, but are not limited to, a synchronization circuit (e.g., electronic, hardware) and a synchronization module (e.g., implemented in software, simulated in software, or the like). As used herein, the term “synchronizer” (and, likewise, the term “synchronizing circuit”) refers to any of a plurality of synchronization circuits, systems, modules, etc., that has a non-linear characteristic, including but not limited to the non-linear circuits, systems, modules, etc., that are described in the '660 patent. For example, a synchronizer may be or comprise a Chua type of circuit, a chaotic circuit, or any similar or suitable nonlinear circuit, including those described in the '660 patent.

As used herein, the term “_{P}SPS” refers to a 1-phase self-synchronizing power system.

As used herein, the term “_{PP}SPS” refers to a poly-phase self-synchronizing power system.

As used herein, a phase offset will be rendered in positive degrees only, starting at 0° without regard for any phase order or sequence (e.g., for a 3-phase system: 0°, 120°, 240°).

As used herein, the term “power system” is generally referencing an “electricity system” or “electrical system” and need not be understood as referencing or being limited to wattage.

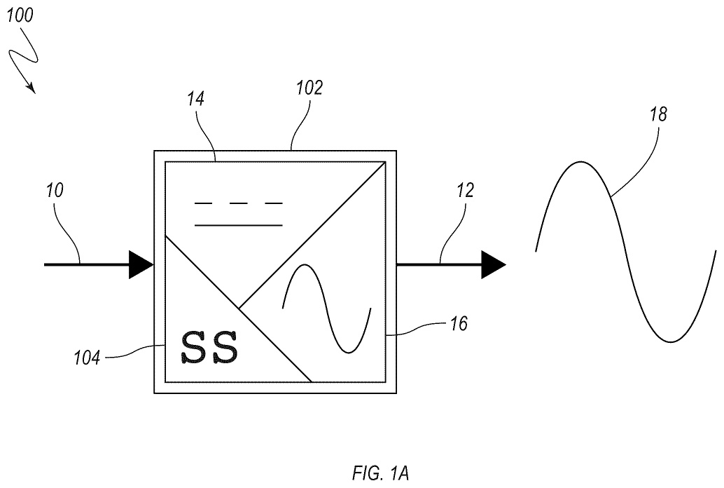

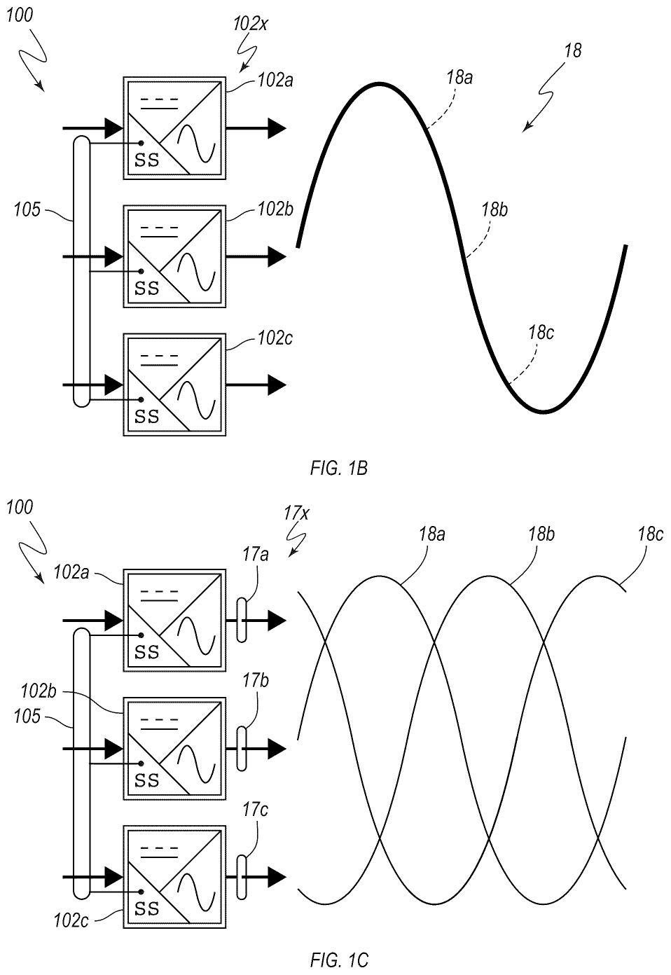

FIG. 1A is a block diagram of a self-synchronizing power system (“SPS”) 100, according to an embodiment of the present disclosure. The SPS 100 of FIG. 1A comprises a direct current (“DC”) input 10, an alternating current (“AC”) output 12, and a 1-phase self-synchronizing power system (“_{P}SPS”) 102. The _{P}SPS 102 comprises a DC link 14, an inverter 16, and a synchronizer 104. The synchronizer 104 may be a nonlinear circuit, such as a Chua circuit or similar chaotic circuit, including but not limited to such as are described in the '660 patent. In an example, the synchronizer 104 may be a non-linear subsystem control. In an example, the synchronizer 104 may be a non-linear subsystem driver.

The _{P}SPS 102 as a single system of the SPS 100 functions similarly to the existent art, but significantly differs structurally therefrom, enabling extension of functionality. The synchronizer 104 may comprise a hardware and/or software component that allows the synchronizer 104 to vary the functionality of the _{P}SPS 102, as further described below. In the existing art, a 3-phase power system typically includes a bridge specifically configured for the given application. By comparison, the _{P}SPS 102, and, more particularly, the synchronizer 104 eliminates the degree of specificity in design necessary for the bridge (and also expands on the degree of versatility). Combining a plurality of _{P}SPSs 102 can enable configuration of an electricity system with ease and simplicity when compared to the current state of the art.

FIG. 1B is a block diagram of an SPS 100, according to an embodiment of the present disclosure, and comprising a plurality of _{P}SPSs 102a, 102b, 102c (collectively, 102x). The _{P}SPSs 102x can be, in essential points, identical to each other. Furthermore, the _{P}SPSs 102x are similar in at least some ways to the SPS 102 of FIG. 1A. The synchronizers of the _{P}SPSs 102x are connected and interact to enable or otherwise facilitate the synchronization. A sync connection 105 provides the interconnection of the synchronizers of the _{P}SPSs 102x. The _{P}SPS 102a is outputting electricity having a waveform 18a. In the embodiment of FIG. 1B, the SPS 100 is configured to produce 1-phase electricity. The _{P}SPS 102b is outputting electricity having a waveform 18b. The _{P}SPS 102c is outputting electricity having a waveform 18c. The self-synchronizing functionality of the _{P}SPSs 102x causes the waveforms 18a, 18b, 18c to be in synchronization as a waveform 18. Said otherwise, the SPS 100 is a stacked SPS comprising a plurality of _{P}SPSs to output 1-phase electricity. Any number of _{P}SPSs 102x may be stacked in this manner.

FIG. 1C is a block diagram of an SPS 100, according to an embodiment of the present disclosure, and comprising a plurality of _{P}SPSs 102a, 102b, 102c (generally or collectively 102x). The _{P}SPSs 102x can be, in essential points, identical to each other. Furthermore, the _{P}SPSs 102x are similar in at least some ways to the SPS 102 of FIG. 1A. The _{P}SPS 102a is outputting or otherwise providing electricity having a waveform 18a. The _{P}SPS 102b is outputting or otherwise providing electricity having a waveform 18b. The _{P}SPS 102c is outputting or otherwise providing electricity having a waveform 18c. The synchronizers of the _{P}SPSs 102x are connected and interact to enable or otherwise facilitate the synchronization. A sync connection 105 provides the interconnection of the synchronizers of the _{P}SPSs 102x. Electrically coupled to the _{P}SPS 102a is a phase shifter 17a. Electrically coupled to the _{P}SPS 102b is a phase shifter 17b. Electrically coupled to the _{P}SPS 102c is a phase shifter 17c. The phase shifters 17a, 17b, 17c (generally or collectively 17x) may each be a filter or any other device known in the art for shifting phase in electricity. The phase shifters 17x are configured to shift the phase of the relevant 1-phase output from the associated _{P}SPSs 102x. By way of non-limiting example, the phase shifter 17a may ensure the output of the _{P}SPS 102a is at 0°, while the phase shifter 17b may ensure the output of the _{P}SPS 102b is at 120°, and the phase shifter 17c may ensure the output of the _{P}SPS 102c is at 240°. The output of the _{P}SPSs 102x can thus comprise a 3-phase electrical output. Each individual phase is controllable independently of the other phases.

While each of the phase shifters 17x are depicted in FIG. 1C as a separate component distinct from the _{P}SPSs 102x, a phase shifter 17x and a corresponding _{P}SPS 102x may be integrated. Stated otherwise, a phase shifter 17x can be associated with a self-synchronization (e.g., process) of an _{P}SPSs 102x. In other words, a phase shifter 17x can, but need not, provide direct phase shifting of the output of a _{P}SPSs 102x. Self-synchronization and integrated phase shifting may be low power. Phase shifting directly the output of a _{P}SPS 102x may be high power. Different applications may warrant different positioning of the phase shifters 17x relative to the _{P}SPSs 102x.

In an embodiment providing n-phase electricity, each of the phase shifters 17x is configured to shift a respective phase to be offset by 360/n from adjacent phases of the n phases. Stated otherwise, the phases of the n-phase electricity are each offset incrementally by 360 degrees divided by n. In one nonlimiting example, if n is equal to 4, then Phase A may be offset by 0°, Phase B may be offset to 90°, Phase C may be offset to 180°, and Phase D may be offset to 270°, and thus every phase of the 4-phase electricity is offset by 90° (or 360°/4) from adjacent phases. Each individual phase is controllable independently of the other phases. In another nonlimiting example, if n is equal to 5, then Phase A may be offset by 0°, Phase B may be offset to 72°, Phase C may be offset to 144°, Phase D may be offset to 216°, and Phase E may be offset to 288° and thus every phase of the 5-phase electricity is offset by 72° (or 360°/5) from adjacent phases. Each individual phase is controllable independently of the other phases.

While FIG. 1C illustrates 3-phase electricity (e.g., n is 3) and three phase shifters 17a, 17b, 17c are shown, two phase shifters may be sufficient. Stated otherwise, an SPS 100, according to an embodiment of the present disclosure, can comprise at least n−1 phase shifters.

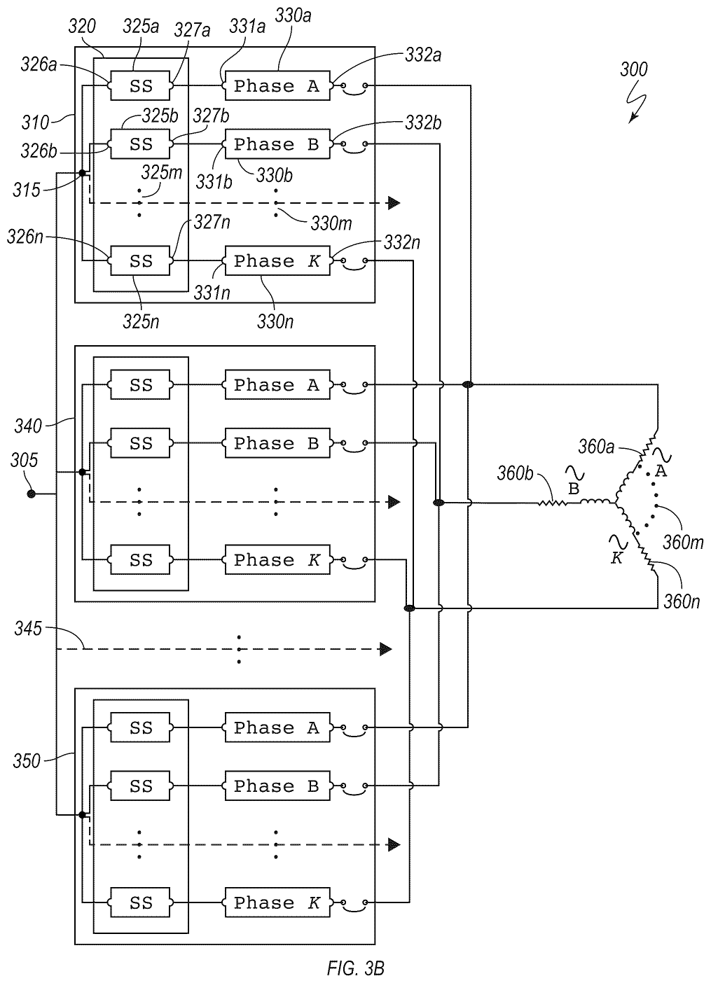

Any number of _{P}SPSs 102x may be stacked in this manner to produce poly-phase electrical output as may be needed for any particular application. Furthermore, the synchronizer of each of the _{P}SPSs 102x may be hardware or software configurable to enable reconfiguration of the electrical output without the need to swap out equipment (as is necessary in the current art). As shown below (see FIGS. 3A and 3B), any number of _{P}SPSs 102x may be used in embodiments that combine the stacking embodiment of FIG. 1B with the stacking embodiment of FIG. 1C.

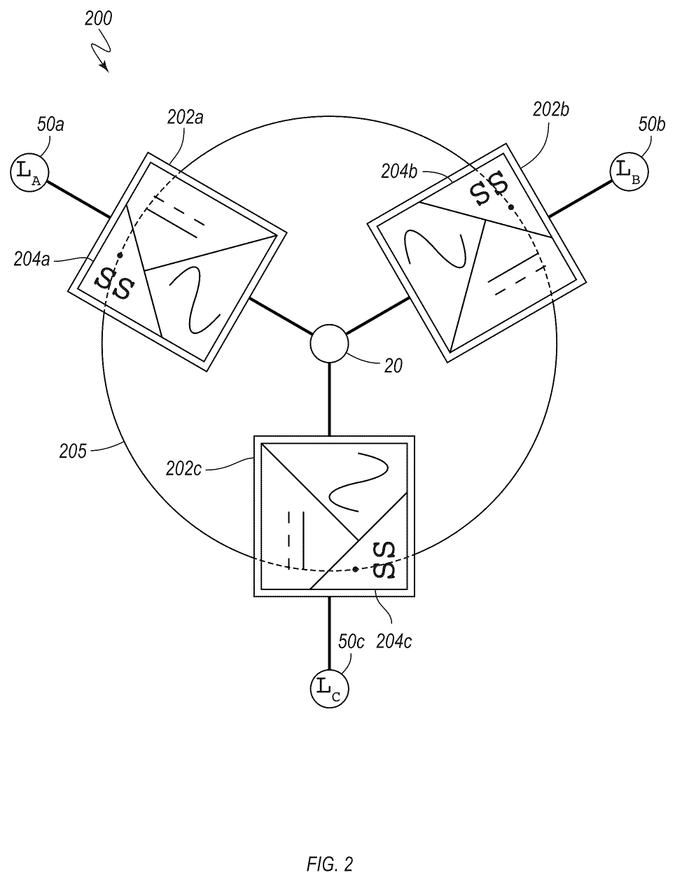

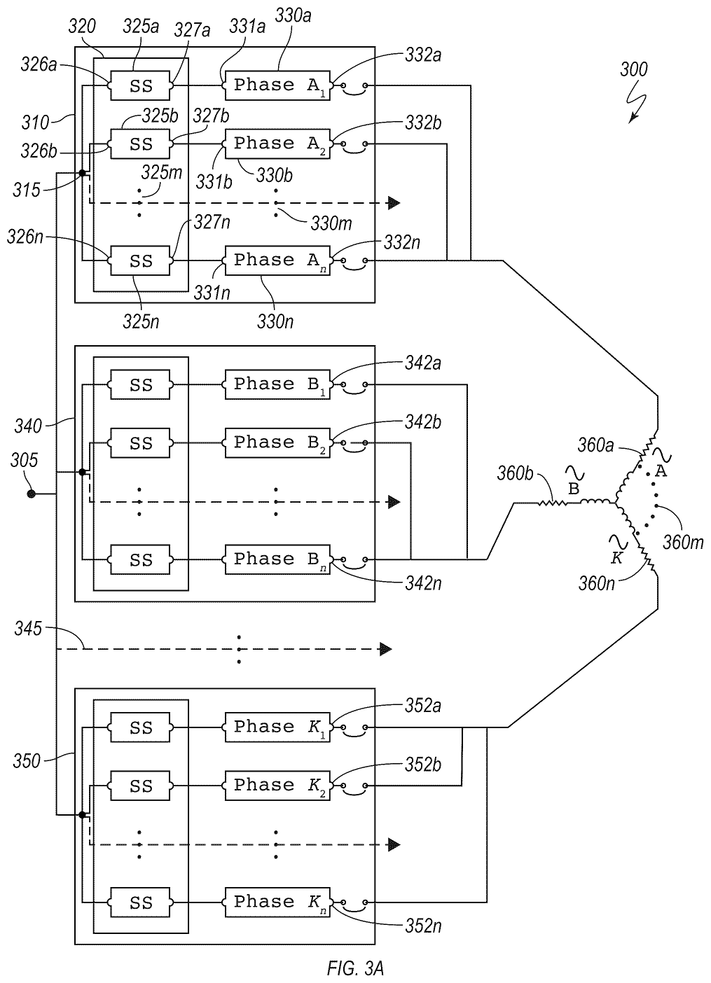

FIG. 2 is a block diagram of an SPS 200, according to an embodiment of the present disclosure, and comprising a plurality of _{P}SPSs 202a, 202b, 202c. Each of the _{P}SPSs 202a-202c may be similar in at least some respects to the _{P}SPS 102 of FIG. 1A. A neutral 20 is shown for reference. A synchronizer 204a, 204b, 204c is identified for each of the _{P}SPSs 202a-202c. The synchronizers 204a-204c each include and/or provide self-synchronizing capability as enabled by nonlinear circuitry, devices, modules, units, and the like. Examples of synchronizers that include nonlinear circuitry, nonlinear devices, nonlinear modules, nonlinear units, and the like, can include those described in the '660 patent. A sync connection 205 interconnects the synchronizers 204 of the _{P}SPSs 202-202c to enable or otherwise facilitate synchronization. The _{P}SPSs 202a-202c collectively can provide synchronized, phase-shifted AC electricity, or three-phase power, similar to the _{P}SPSs 102x of FIG. 1A. Each individual phase is controllable independently of the other phases. The AC outputs couple to and deliver electricity to a 3-phase load, which is indicated in FIG. 2 as L_{A} 50a, L_{B} 50b, and Lc 50c. The architecture of the SPS 200 is more fully clarified in the descriptions of FIGS. 3A and 3B.

FIG. 3A is a diagram of an SPS 300, according to an embodiment of the present disclosure, wherein the SPS 300 is a stacked SPS and includes a plurality of 1-phase SPSs (“_{P}SPS;” collectively, “_{P}SPSs”). The SPS 300 can generate k-phase electricity having k-phases. (Note: The variables k and n are used herein freely, and sometimes interchangeably, for describing the scalability of the technology to generate poly-phase AC electricity. However, k is most often used to denote a number of phases and n is most often used to denote a number of a component, such as a synchronizer, converter, system, SPS, or the like.) As described in FIGS. 1B and 1C, the _{P}SPSs can be stackable and in FIG. 3A the _{P}SPSs are in a stacked configuration (“stacked SPS”) with each _{P}SPS producing a single phase of the k phases. The SPS 300 comprises at least a first _{P}SPS 310, a second _{P}SPS 340, and an nth _{P}SPS 350. The _{P}SPSs 310, 340, 350, are combined to generate k-phase electricity to power the load 360. The first _{P}SPS 310 is more fully described, and the description thereof can be equally applicable to the other _{P}SPSs 340 . . . 350, including any _{P}SPSs between the second _{P}SPS 340 and the nth _{P}SPS 350. The _{P}SPSs 310, 340, 350 illustrate that the systems described herein can be stacked within a single _{P}SPSs and synchronized as a set to generate a single phase of a poly-phase output.

The first _{P}SPS 310 comprises at least a first synchronizer 325a, a second synchronizer 325b, an nth synchronizer 325n, and may comprise (an) additional synchronizer(s) 325m. Each synchronizer 325a-325n includes, provides, and/or otherwise operates with self-synchronizing capability. Each synchronizer 325a-325n may comprise at least one Chua circuit, a chaotic circuit, or a similar nonlinear circuit, including such as are described in the '660 patent. Each of the synchronizers 325a-325n comprises an X-node 326a, 326b, 326m, 326n, respectively, and a Y-node 327a, 327b, 327m, 327n, respectively.

The first _{P}SPS 310 further comprises at least a first 1-phase AC (“phase A₁”) system 330a, a second 1-phase AC (“phase A₂”) system 330b, an nth 1-phase AC (“phase Aₙ”) system 330n, and may further comprise any number of additional 1-phase AC (“phase(s) Aₘ”) systems 330m. Each AC system 330a-330m can include or otherwise be associated with an inverter and/or other appropriate electronic device and/or circuitry. The phase A₁, phase A₂, phase(s) Aₘ, and phase Aₙ systems 330a-330n each comprises a control node 331a, 331b, 331m, 331n, respectively, and an output node 332a, 332b, 332m, 332n, respectively. The Y-node 327a of the first synchronizer 325a is coupled to the control node 331a of the phase A₁ system 330a. The Y-node 327b of the second synchronizer 325b is coupled to the control node 331b of the phase A₂ system 330b. The Y-node(s) 327m of any mth synchronizers 325m is/are coupled to the control node(s) 331m of the corresponding phase Aₘ system(s) 330m. The Y-node 327n of the nth synchronizer 325n is coupled to the control node 331n of the phase Aₙ system 330n. The synchronizers 325a-325n each comprise a hardware and/or a software component whereby each synchronizer 325a-325n may be configured for the particular application. By way of non-limiting example, in FIG. 3A, each of the synchronizers 325a, 325b, 325n may be configured to provide a uniform phase offset of 0°. In other words, any number of synchronizers 325a-325n (each representing a phase A₁-Aₙ system) may be present in the first _{P}SPS 310 and the synchronizers 325a-325n will ensure a uniform 0° offset for the _{P}SPS 310. Stated otherwise, the systems 330a-330n are a set of systems connected in parallel to an identical phase of k phases.

The X-nodes 326a-326n of the synchronizers 325a-325n are communicatively coupled via a local node 315. Coupling of the X-nodes 326a-326n forms an X-X control network described in the '660 patent as a peer to peer synchronized network. With the synchronizers 325a-325n communicatively coupled, each of the synchronizers 325a-325n is enabled to regulate (e.g., synchronize) the respective phase A₁, phase A₂, phase Aₘ, phase Aₙ systems 330a-330n. Coupling the synchronizers 325a-325n (via their respective X-nodes 326a-326n) forms a non-linear control subsystem 320. Use of the synchronizers 325a-325n enables synchronization without generation of feedback, circuit noise, drift, etc. This is true even at higher orders of stacking. Thus, creating, for example, an 80-phase A, systems _{P}SPS can be accomplished through the methods and systems herein described without the generation of destructive interference, feedback, etc. In FIG. 3A, the output nodes 332a of each phase Aₙ system of the _{P}SPS 310 are coupled in parallel to the phase A 360a of the load 360.

The _{P}SPS 310 can be coupled with other _{P}SPSs 340, 350 to provide a k-phase AC electricity output. Output nodes 342a, 342b, 342n of the _{P}SPS 340 are identified for reference. The output nodes 342a, 342b, 342n are coupled to a phase B 360b of the load 360. Stated otherwise, the _{P}SPSs 340 can provide a phase B 360b of a k-phase AC electricity output. Output nodes 352a, 352b, 352n of the _{P}SPS 350 are also identified for reference. The output nodes 352a, 352b, 352n are coupled to the phase K 360n of the load 360. While each of the synchronizers 325a-325n of the first _{P}SPS 310 are coupled at the local node 315 to enable synchronization of the phases within the first _{P}SPS 310, the local node 315 of each _{P}SPS 310-350 is likewise coupled at a central node 305 whereby synchronization among the plurality of _{P}SPSs 310-350 is facilitated. The central node 305 couples and thereby synchronizes a poly-phase, self-synchronizing, non-linear and/or chaotic control system, namely the stacked SPS 300, which is a self-synchronized poly-phase power system.

In a more-than-3-phase system, the output nodes (analogous to output nodes 332a, 332b, 332n) will each be connected to a respective phase 360m of the load 360. For a symmetric k-phase power system, the relative phase shift between phases is given by 360°/k. Thus, the SPS 300 of FIG. 3A can provide scalability to generate k-phase electricity, where k is any number, by combining and syncing n systems 330n together to produce a phase of the k phases, where n is any number of one or more systems, and by then combining k _{P}SPSs 310-350 to generate all k phases.

FIG. 3B is a diagram of an SPS 300, according to another embodiment of the present disclosure, wherein the SPS 300 is a stacked SPS and includes a plurality of polyphase SPSs (“_{PP}SPS,” “_{PP}SPSs”). Each _{PP}SPS can generate each phase of a poly-phase output. Multiple _{PP}SPSs can be stackable and in FIG. 3B they are in a stacked configuration (“stacked SPS”). The SPS 300 comprises at least a first _{PP}SPS 310, a second _{PP}SPS 340, and an nth _{PP}SPS 350. The _{PP}SPS 310, 340, 350 are combined to produce k-phase electricity to power the load 360. The first _{PP}SPS 310 is more fully described, and the description thereof is equally applicable to the other _{PP}SPSs 340 . . . 350, including any _{PP}SPSs between the second _{PP}SPS 340 and the nth _{PP}SPS 350.

The first _{PP}SPS 310 comprises at least a first synchronizer 325a, a second synchronizer 325b, an nth synchronizer 325n, and may comprise (an) additional synchronizer(s) 325m. Each synchronizer 325a-325n includes, provides, and/or otherwise operates with self-synchronizing capability. Each synchronizer 325a-325n may comprise at least one Chua circuit, a chaotic circuit, or a similar nonlinear circuit, such as are described in the '660 patent. Each of the synchronizers 325a-325n comprises an X-node 326a, 326b, 326m, 326n, respectively, and a Y-node 327a, 327b, 327m, 327n, respectively.

The first _{PP}SPS 310 further comprises at least a first 1-phase AC (“phase A”) system 330a, a second 1-phase AC (“phase B”) system 330b, an nth 1-phase AC (“phase K”) system 330n, and may further comprise any number of additional 1-phase AC (“phase(s) m”) systems 330m. The phase A, phase B, phase(s) m, and phase K systems 330a-330n each comprises a control node 331a, 331b, 331m, 331n, respectively, and an output node 332a, 332b, 332m, 332n, respectively. The Y-node 327a of the first synchronizer 325a is coupled to the control node 331a of the phase A system 330a. The Y-node 327b of the second synchronizer 325b is coupled to the control node 331b of the phase B system 330b. The Y-node(s) 327m of any mth synchronizers 325m is/are coupled to the control node 331m of the corresponding phase m system 330m. The Y-node 327n of the nth synchronizer 325n is coupled to the control node 331n of the phase K system 330n. The synchronizer 325a-325n each comprise a hardware and/or a software component whereby each synchronizer 325a-325n may be configured for the particular application. By way of non-limiting example, for a 3-phase power system, each of the synchronizers 325a, 325b, 325n may be configured to provide a respective phase offset of 0°, 120°, and 240°. In a 5-phase power system, each of the synchronizers 325a-325n may be configured to provide a respective phase offset of 0°, 72°, 144°, 216°, and 288°; i.e. the relative phase shift between phases is 360°/5=72°. The X-nodes 326a-326n of the synchronizers 325a-325n are communicatively coupled via a local node 315. Coupling of the X-nodes 326a-326n forms an X-X control network described in the '660 patent as a peer-to-peer synchronized network. With the synchronizers 325a-325n communicatively coupled, each of the synchronizers 325a-325n is enabled to regulate (synchronize) the respective phase A, phase B, phase m, phase K systems 330a-330n. Coupling the synchronizers 325a-325n (via their respective X-nodes 326a-326n) forms a non-linear control subsystem 320. Use of the synchronizers 325a-325n enables synchronization without generation of feedback, circuit noise, drift, etc. This is true even at higher orders of stacking. Thus, creating, for example, an 80-phase power system can be accomplished through the methods and systems herein described without the generation of destructive interference, feedback, etc.

The output node 332a of the _{PP}SPS 310 and the analogous output nodes of each _{PP}SPS 340, 345, 350 are coupled to the phase A 360a of the load 360. Similarly, the output node 332b of the _{PP}SPS 310 and the analogous output nodes of each _{PP}SPS 340, 345, 350 are coupled to the phase B 360b of the load 360. The output nodes 332n of the _{PP}SPS 310 and the analogous output nodes of each _{PP}SPS 340, 345, 350 are coupled to the phase K 360n of the load 360. If present, the output nodes (not shown) of each iteration of _{PP}SPS 345 are coupled to the respective phase m 360m of the load 360. While each of the synchronizers 325a-325n of the first _{PP}SPS 310 are coupled at the local node 315 to enable synchronization of the phases within the first _{PP}SPS 310, the local node 315 of each _{PP}SPS 310, 340, 345, 350 is likewise coupled at a central node 305 whereby synchronization among the plurality of _{PP}SPSs 310, 340, 345, 350 is facilitated. The central node 305 couples and thereby synchronizes a poly-phase, self-synchronizing, non-linear and/or chaotic control system, the stacked SPS 300, which is a self-synchronized poly-phase power system. The _{PP}SPSs 310, 340, 345, 350 both current share and power the poly-phase load 360. Current sharing of the stacked SPS 300 is a result of Ohm's Law and needs no further controlling, thus the stacked SPS 300 and the member _{PP}SPSs 310, 340, 345, 350 need no additional components. Furthermore, the stacked SPS 300 and the member _{PP}SPSs 310, 340, 345, 350 inherently avoid the circuit noise, feedback and other detrimental effects of currently available stacking systems.

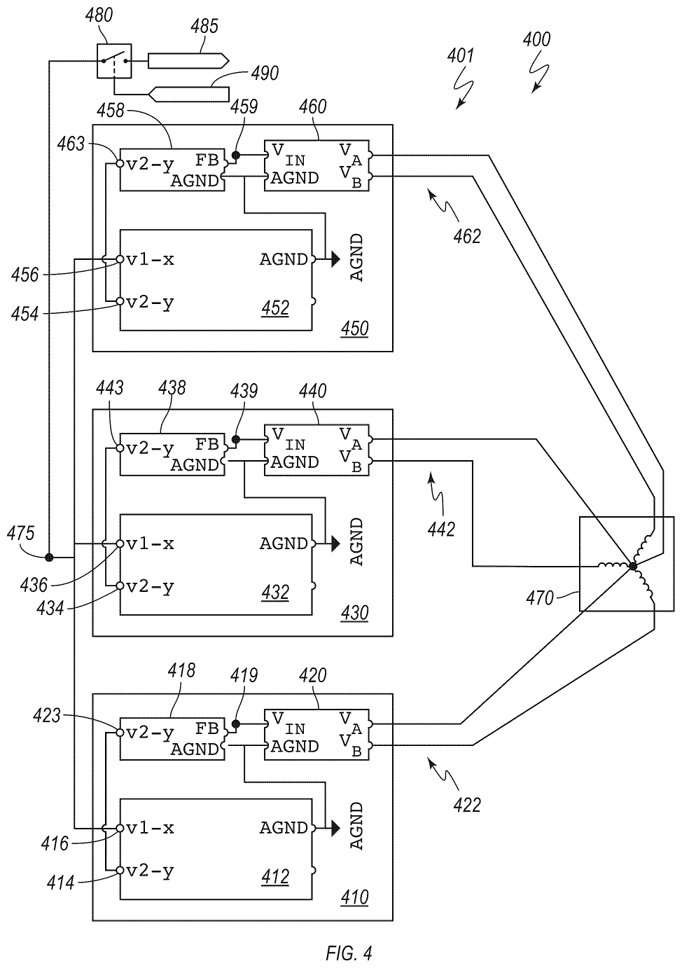

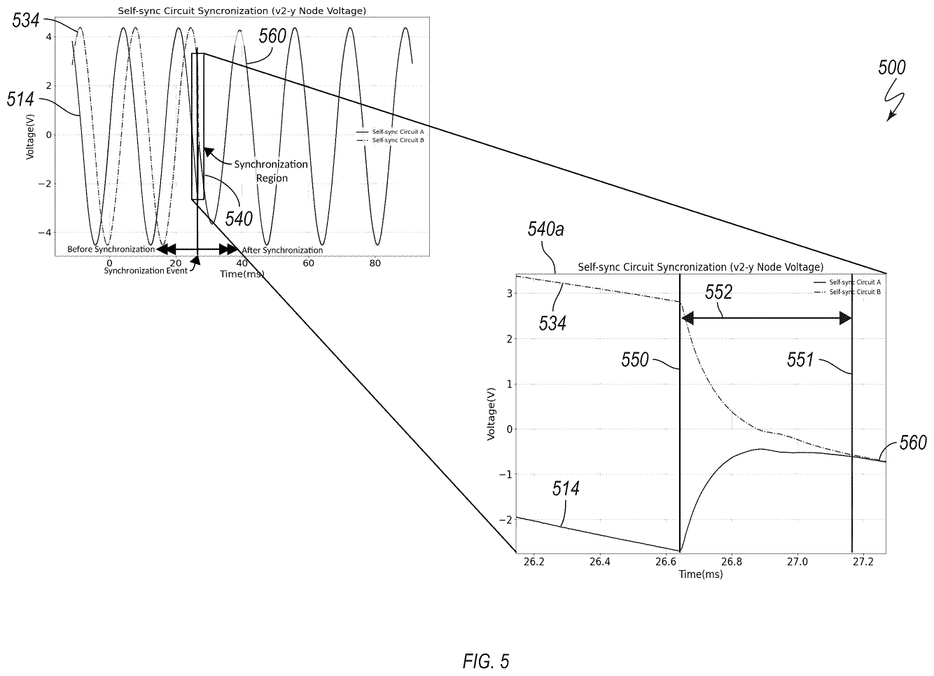

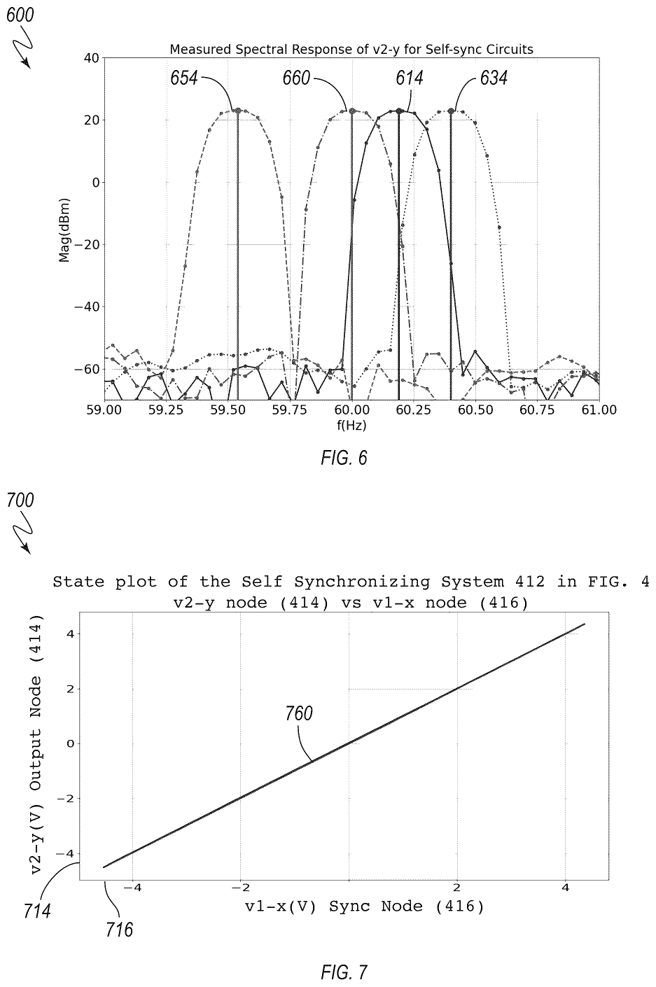

FIG. 4 is a diagram of a stackable SPS 400, according to an embodiment of the present disclosure, and comprising a 3-phase power system 401 and a 3-phase load 470. The stackable SPS 400 further comprises a network switch 480, a central network node 485, and a central node control network 490. The stackable SPS 400 also comprises a first _{P}SPS 410, a second _{P}SPS 430, and a third _{P}SPS 450. The first, second, and third _{P}SPSs 410, 430, 450 are stackable and/or scalable. Each of the _{P}SPSs 410, 430, 450 comprises a synchronizer 412, 432, 452, respectively that may be non-linear, chaotic, etc., and is self-synchronizing, and resonant, as described in the '660 patent. Each synchronizer 412, 432, 452 comprises a v2-y node 414, 434, 454, respectively, and v1-x node 416, 436, 456, respectively. Each of the _{P}SPSs 410, 430, 450 further comprises a phase shift filter 418, 438, 458, respectively, and a full bridge circuit 420, 440, 460, respectively. Each v1-x node 416, 436, 456 is coupled to a central node 475. Coupling the v1-x nodes 416, 436, 456 enables synchronization between the three _{P}SPSs 410, 430, 450 and also enables stacking the stackable SPS 400. The central node 475 couples the v1-x nodes 416, 436, 456 via the network switch 480 to the central network node 485. The central network node 485 is coupled to and controlled by the central node control network 490.

For each _{P}SPS 410, 430, 450, the v2-y node 414, 434, 454 of the respective synchronizer 412, 432, 452 couples to the v2-y node 419, 439, 459 of a respective phase shift filter 418, 438, 458. The phase shift filters 418, 438, 458 may comprise a hardware and/or software, digital or analog means for shifting the phase of the voltage. Each phase shift filter 418, 438, 458 shifts the phase of the electricity flowing through it according to the phase requirement for the particular application. In the embodiment of FIG. 4, the application is a 3-phase power and load, thus, for example, the first phase shift filter 418 may regulate the voltage phase of the first _{P}SPS 410 to 0° while the second phase shift filter 438 may advance the voltage phase of the second _{P}SPS 430 to 120° and the third phase shift filter 458 may advance the voltage phase of the third _{P}SPS 450 to 240°. Each phase shift filter 418, 438, 458 electrically couples to a respective full bridge circuit 420, 440, 460. Each full bridge circuit 420, 440, 460 electrically couples to a full bridge inverter 422, 442, 462, respectively. Each full bridge inverter 422, 442, 462 couples to the 3-phase load 470. In this manner, fully synchronized and phase shifted voltage is delivered to the 3-phase load, and the feedback, circuit noise, and other drawbacks of the currently available art are avoided.

FIG. 5 is a chronometry plot 500 of voltages taken from a built embodiment of the stackable SPS of FIG. 4 (see SPS 400). The voltage was sampled at the v2-y nodes of the synchronizers of the first and second _{P}SPSs (see the v2-y nodes 414, 434, the synchronizers 412, 432, the first _{P}SPS 410, and the second _{P}SPS 430 in FIG. 4). For the built embodiment of the stackable SPS, a resultant 60 Hz system was targeted. The resonant frequency of the synchronizer of the first _{P}SPS was tuned to 60.06 Hz, and the resonant frequency of the synchronizer of the second _{P}SPS was tuned 60.04 Hz. A switch was coupled between v1-x nodes of the NSCs of the first and second _{P}SPSs. Closing the switch resulted in a synchronization event and the two circuits were synchronized. The voltage phase 514 of the first _{P}SPS prior to the synchronization event is plotted to the chronometry plot 500, as is the voltage phase 534 of the second _{P}SPS. The synchronization event is shown in a synchronization event window 540. An expanded view 540a of the synchronization event window 540 is shown. The synchronization event 550 is shown in the expanded view 540a. The voltage phases 514, 534 of the respective _{P}SPSs 410, 430 are shown in the expanded view 540a prior to the synchronization event 550. The measured completion 551 of the synchronization event 550 is shown. The duration 552 of the synchronization event 550 was measured at 576 μs, after which the synchronized voltage phase 560 is shown. During the 576 us convergence duration 552 comprises about 3/100s of the 16.7 ms cycle of voltage phases 514, 534.

FIG. 6 is a spectral response graph 600 for voltages of the v2-y nodes of the first, second, and third synchronizers of the _{P}SPSs of built embodiment of the stackable SPS of FIG. 4 (see the v2-y nodes 414, 434, 454, the synchronizers 412, 432, 452, the _{P}SPSs 410, 430, 450, and the stackable SPS 400 of FIG. 4), both before and after synchronization. The resonant frequencies of the synchronizers were tuned away from the system target of 60 Hz. More particularly, the resonant frequency of the first synchronizer was tuned to 60.2 Hz, the resonant frequency of the second synchronizer was tuned to 60.4 Hz, and the resonant frequency of the third synchronizer was tuned to 59.5 Hz. The pre-synchronization voltage plots 614, 634, 654 for the respective synchronizers are shown on the spectral response graph 600. The synchronizers were electrically coupled to each other across their respective v1-x nodes (see the v1-x nodes 416, 436, 456 in FIG. 4), triggering a synchronization event. Following the synchronization event, the resonant frequencies were again sampled at the v2-y nodes. The resulting, synchronized voltage phases are shown at the voltage plot 660. The resulting, synchronized resonant frequency is the mean of the constituent resonant frequencies of each of the synchronizers (i.e., (60.2+60.4+59.5)/3=60). This behavior continues as more synchronizers are synchronized, resulting in Equation 1:

$${f}_{net}^{′} = \frac{1}{N + 1} {f}_{node}^{′} + \frac{N}{N + 1} {f}_{net}$$

where:
N is the number of nodes in network to which the new node (NSC) is being added
f″ₙₑₜ [symbol] is the frequency of new network
f′_{node} [symbol] is the frequency of added node
fₙₑₜ [symbol] is the frequency of old network
   Hence, as more synchronizers are added, the resulting synchronized resonant frequency becomes more stable, where each new synchronizer will only change the new synchronized resonant frequency by 1/(N+1) times the new synchronizer's resonant frequency.

If a population of m _{PP}SPSs of n-phase with n synchronizers (see, e.g., SPS 300 of FIG. 3B) is increased by the addition of one _{PP}SPS of n-phase, then:

$${f}_{net}^{′} = \frac{n}{nm + n} {f}_{node}^{′} + \frac{nm}{nm + n} {f}_{net}$$

where:
n [symbol] is the number of phases in each node of the network
m [symbol] is the number of nodes to which the new node is being added
f′ₙₑₜ [symbol] is the frequency of new network
f′_{node} [symbol] is the frequency of added node
fₙₑₜ [symbol] is the frequency of old network
   yielding Equation 2:

$${f}_{net}^{′} = \frac{1}{m + 1} {f}_{node}^{′} + \frac{m}{m + 1} {f}_{net}$$

Since Equation 2 is the same as Equation 1, a system (or network) of n-phase s synchronizers behaves identically to a network of individual synchronizers. (Note: As indicated previously, the variables k and n are used herein freely, and sometimes interchangeably, for describing the scalability of the technology to generate poly-phase AC electricity. The variable k is most often used to denote a number of phases and the variable n is most often used to denote a number of a component, such as a synchronizer, converter, system, SPS, or the like. However, in the foregoing equations, the variable n is denoting a number of phases, as stated.)

FIG. 7 is a comparative voltage plot 700 for the post-synchronization voltages at a v2-y node and a v1-x node of a synchronizer in a built embodiment of the stackable SPS of FIG. 4 (see the v2-y node 414, 434, 454, the v1-x node 416, 436, 456, the synchronizers 412, 432, 452, and the stackable SPS 400 in FIG. 4). For each synchronizer, there is no hysteresis in the v2-y/v1-x voltages. Upon connection of all the v1-x nodes, synchronization exists for all the synchronizers. Since there is a one-to-one correspondence of v1-x to v2-y within each synchronizer, the v2-y voltages for each synchronizer are synchronized to each other. The voltage at each of the three v2-y nodes are available to each of the synchronizers for use in driving power stages downstream from them. In the embodiment of the 3-phase stackable SPS, the v2-y voltages are each handed into a phase shift filter for the respective _{P}SPS (see the phase shift filters 418, 438, 458 and the _{P}SPSs 410, 430, 450 of FIG. 4).

Additional testing with a built embodiment of the stackable SPS of FIG. 400 employing, at the v2-y node of the second phase shift filter, a 2-stage, 4-pole Butterworth, Low Pass Filter, providing 240° voltage phase shift and near 0 dB gain at 60 Hz at the phase shift filter revealed a +0.5 dB gain at 60 Hz (see the v2-y node 443, the phase shift filter 438, and the stackable SPS 400 in FIG. 4). At the v2-y node of the third phase shift filter, a 1-Stage, 2-Pole Butterworth, Low Pass Filter and Inverting Amplifier, providing −240° voltage phase shift and near 9 dB gain at 60 Hz revealed a −0.9 dB gain at 60 Hz (see the v2-y node 463 and the phase shift filter 458 in FIG. 4). In addition to the second and third phase shift filters providing the required phase shifts, respectively, the second and third phase shift filters also reduced Total Harmonic Distortion (“THD”) by virtue of a higher harmonic roll-off performance. For the first phase shift filter (see the phase shift filter 418 in FIG. 4), a 2-Stage, 4-Pole Butterworth Band Pass Filter revealed at the center of the pass-band, 60 Hz, a 0° phase shift exists, and THD is reduced. No filter is actually required for the 0° phase shift filter when using higher quality rail-to-rail OpAmps, and using lower quality OpAmps still produces less THD than in the currently available art.

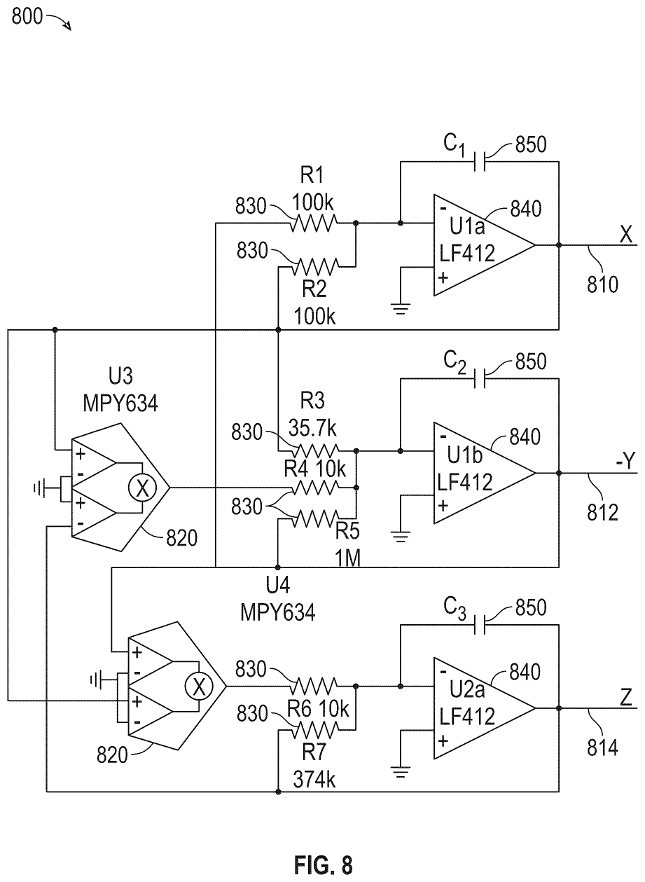

FIG. 8 is a circuit diagram of an example synchronization unit including a non-linear circuit 800, according to an embodiment of the present disclosure. This example embodiment of a non-linear circuit 800 is based off a Lorenz system which outputs voltage and/or current references X, −Y, and Z shown as inputs and outputs 810, 812, 814. This illustrated embodiment of a nonlinear circuit 800 includes energy storage components in the form of capacitors 850, locally active resistance in the form of resistors 830, and non-linear elements in the form of a combination of multipliers 820, such as an MPY634. The circuit 800, with this set of components, is capable of non-linear and chaotic behavior. The capacitors 850 resistors 830, R1-R7, shown are simply examples and other forms of energy storage components and/or resistance could be used, in other embodiments. Similarly, while the arrangement of multipliers 820 provides nonlinearity to the circuit 800, in other embodiments of nonlinear circuits a different form of nonlinear element may be provided. The circuit 800 also includes op-amp devices 840 such as an LF412. By changing the value of the capacitors 850, the frequency output at the output X 810, output-Y 812, and output Z 814 of the system 800 can be adjusted.

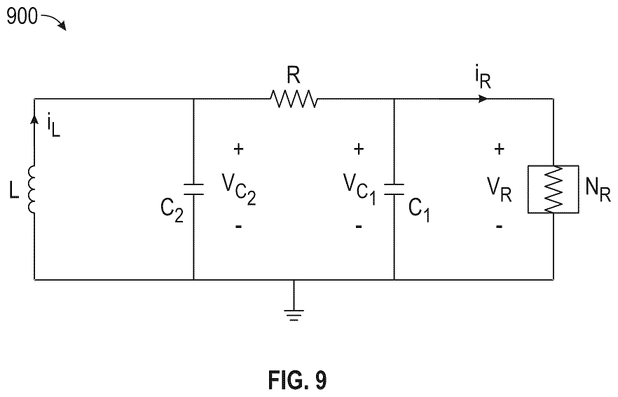

FIG. 9 is a circuit diagram of an Ideal Chua Circuit 900, which may be utilized a synchronization unit to implement or otherwise provide a non-linear characteristic or chaotic characteristic for the synchronization unit to enable self-synchronization capability. The circuit 900 shown in FIG. 9, which demonstrates the self-synchronizing of chaotic systems, is made up of capacitors, resistors, inductors, and the non-linear Chua diode NR. This embodiment provides a Chua circuit that is capable of chaotic and limit-cycle behavior.

### EXAMPLES

Some examples of embodiments of the present disclosure are provided below.

Example 1. A self-synchronizing system of multiple (e.g., k, or more), 1-phase inverters for converting direct current (DC) electricity to k-phase alternating current (AC) electricity, comprising: a plurality (n) of DC inputs for receiving DC electricity; n converter circuits each to convert DC electricity at a corresponding DC input to produce single phase AC electricity at an AC output; and n synchronizing circuits each to drive a corresponding one of the n converter circuits, each synchronizing circuit of the n synchronizing circuits to operate with a non-linear characteristic, wherein the n synchronizing circuits are connected to drive the n converter circuits to produce k-phase electricity at the AC output with all of the k phases at a single AC frequency. Each phase of the k-phase electricity can be offset by 360 degrees divided by k from other of (e.g. adjacent) the k phases.

Example 2. The self-synchronizing system of Example 1, wherein the AC output of each of the n converter circuits is connected to a different phase of the k phases.

Example 3. The self-synchronizing system of Example 1, wherein the AC outputs of a set of the n converter circuits are connected in parallel to an identical phase of the k phases. Accordingly, n is greater than or equal to k.

Example 4. The self-synchronizing system of Example 1, further comprising: a connection to each of the n synchronizing circuits, the connection for a reference sine-wave AC signal, wherein the n converter circuits are to synchronize to the reference sine-wave AC signal.

Example 5. The self-synchronizing system of Example 1, further comprising: at least k−1 phase shifters each to shift the single phase AC electricity output of a corresponding converter circuit to a phase of the k phases to produce the k-phase electricity at the AC output.

Example 6. The self-synchronizing system of Example 1, wherein each synchronizing circuit of the n synchronizing circuits provides bidirectional synchronization with another synchronizing circuit of the n synchronizing circuits.

Example 7. A self-synchronizing poly-phase system of multiple inverters for converting direct current (DC) electricity to k-phase alternating current (AC) electricity, comprising: a plurality of inverters for converting DC electricity to alternating current (AC) electricity, each inverter of the plurality of inverters comprising: multiple (n) converters each to convert the received DC electricity to produce single phase AC electricity at an AC output; and n synchronizers each to drive a corresponding one of the n converter circuits, wherein each synchronizer of the n synchronizers is to operate with a non-linear characteristic, wherein the n synchronizers are connected to drive the n converters to produce k-phase AC electricity at a single AC frequency.

Example 8. The self-synchronizing poly-phase system of Example 7, wherein the AC output of each of the plurality of inverters produces a different phase of the k phases, wherein each of the n converters of each inverter of the plurality of inverters is connected in parallel to an identical phase of the k phases.

Example 9. The self-synchronizing poly-phase system of Example 7, wherein the AC output of each of the n converter circuits of each of the plurality of inverters is connected to a different phase of the k phases.

Example 10. The self-synchronizing poly-phase system of Example 7, each inverter of the plurality of inverters further comprising: a connection to each of the n synchronizers, the connection for a reference sine-wave AC signal, wherein the n converter circuits are to synchronize to the reference sine-wave AC signal.

Example 11. The self-synchronizing poly-phase system of Example 7, further comprising: a connection to each of the n synchronizers of each of the plurality of inverters, the connection for a reference sine-wave AC signal, wherein the n converter circuits are to synchronize to the reference sine-wave AC signal.

Example 12. The self-synchronizing poly-phase system of Example 7, each of the plurality of inverters further comprising: at least k−1 phase shifters each to shift a single phase of AC electricity output by a corresponding converter circuit to a phase of the k phases to produce the k-phase electricity at the AC output.

Example 13. The self-synchronizing poly-phase system of Example 7, wherein each synchronizer of the n synchronizers provides bidirectional synchronization with another synchronizer of the n synchronizers.

Example 14. A self-synchronizing poly-phase inverter for converting direct current (DC) electricity to k-phase alternating current (AC) electricity, comprising: one or more DC inputs for receiving DC electricity; multiple (n) converter circuits each to convert DC electricity to single phase AC electricity, of the k-phase AC electricity, at a first AC output; and a synchronizer to operate with a non-linear characteristic, the synchronizer to drive the n converter circuits to produce all k phases of the k-phase AC electricity at a single AC frequency.

Example 15. The self-synchronizing poly-phase inverter of Example 14, wherein the synchronizer comprises n non-linear circuits to provide the non-linear characteristic of a collapsed or non-hysteretic limit-cycle mode.

Example 16. The self-synchronizing poly-phase inverter of Example 15, wherein the n non-linear circuits give rise to an n-phase synchronizer capable of chaotic behavior.

Example 17. The self-synchronizing poly-phase inverter of Example 14, wherein the synchronizer provides bidirectional synchronization between the self-synchronizing inverter and at least one additional self-synchronizing inverter.

Example 18. The self-synchronizing poly-phase inverter of Example 14, wherein the synchronizer enables synchronized load sharing between the self-synchronizing inverter and at least one additional self-synchronizing inverter.

Example 19. The self-synchronizing poly-phase inverter of Example 14, further comprising: a connection to connect each phase of the k-phase electricity at the first AC output of the self-synchronizing poly-phase inverter to a corresponding phase of one or more other self-synchronizing poly-phase inverters in parallel. Example 20. The self-synchronizing poly-phase inverter of Example 19, wherein synchronizers of the one or more other self-synchronizing poly-phase inverters are connected and the self-synchronizing poly-phase inverter and the one or more other self-synchronizing n-phase inverters collectively produce n-phases at the single AC frequency

Example 21. The self-synchronizing poly-phase inverter of Example 14, further comprising: at least k−1 phase shifters each to shift the single-phase AC electricity output by a corresponding converter circuit to a phase of the k phases to produce the k-phase electricity at the AC output, wherein each phase of the k phases is offset from the other k phases by 360 degrees divided by k.

Example 22. Two identical 120 V self-synchronizing 5 kW inverters can be configured using the principles described herein to yield 120V circuits (i.e. +120V with respect to a reference) each operating at 5 kW along with a single 240V circuit operating at 10 kW.

Example 23. Three identical self-synchronizing 5 kW inverters with appropriate phase shifting may be wye connected to yield a 120V line-to-neutral 15 kW 3-phase system, according to the principles described in the present disclosure. Each of the individual self-synchronizing 5 kW inverters may be additionally paralleled n times to yield a 15n kW 3-phase wye-connected system. Separately, a delta configuration could also be formed.

While various aspects and embodiments have been disclosed herein, other aspects and embodiments are contemplated. The various aspects and embodiment disclosed herein are for purposes of illustration and are not intended to be limiting. It will be apparent to those having skill in the art that many changes may be made to the details of the above-described embodiments without departing from the underlying principles of the disclosure. The scope of the present disclosure should, therefore, be determined only by the following claims.

1. A self-synchronizing system of multiple 1-phase inverters for converting direct current (DC) electricity to k-phase alternating current (AC) electricity, comprising:
one or more of DC inputs for receiving DC electricity;
a plurality (n) of converter circuits each to convert DC electricity at a DC input to produce single phase AC electricity at an AC output; and
n synchronizing circuits each to drive a corresponding one of the n converter circuits, each synchronizing circuit of the n synchronizing circuits to operate with a non-linear characteristic,
wherein the n synchronizing circuits are connected to drive the n converter circuits to produce k-phase electricity at the AC output with all of the k phases at a single AC frequency.

2. The self-synchronizing system of claim 1, wherein the AC output of each of the n converter circuits is connected to a different phase of the k phases.

3. The self-synchronizing system of claim 1, wherein the AC outputs of a set of the n converter circuits are connected in parallel to an identical phase of the k phases.

4. The self-synchronizing system of claim 1, further comprising:
a connection to each of the n synchronizing circuits, the connection for a reference sine-wave AC signal, wherein the n converter circuits are to synchronize to the reference sine-wave AC signal.

5. The self-synchronizing system of claim 1, further comprising:
at least n−1 phase shifters each to shift the single phase AC electricity output of a corresponding converter circuit to a phase of the k phases to produce the k-phase electricity at the AC output.

6. The self-synchronizing system of claim 1, wherein each synchronizing circuit of the n synchronizing circuits provides bidirectional synchronization with another synchronizing circuit of the n synchronizing circuits.

7. A self-synchronizing poly-phase system of multiple inverters for converting direct current (DC) electricity to k-phase alternating current (AC) electricity, comprising:
a plurality of inverters for converting DC electricity to alternating current (AC) electricity, each inverter of the plurality of inverters comprising:
multiple (n) converters each to convert the received DC electricity to produce single phase AC electricity at an AC output; and
n synchronizers each to drive a corresponding one of the n converter circuits, wherein each synchronizer of the n synchronizers is to operate with a non-linear characteristic,
wherein the n synchronizers are connected to drive the n converters to produce k-phase AC electricity at a single AC frequency.

8. The self-synchronizing poly-phase system of claim 7, wherein the AC output of each of the plurality of inverters produces a different phase of the k phases, wherein each of the n converters of each inverter of the plurality of inverters is connected in parallel to an identical phase of the k phases.

9. The self-synchronizing poly-phase system of claim 7, wherein the AC output of each of the n converter circuits of each of the plurality of inverters is connected to a different phase of the k phases.

10. The self-synchronizing poly-phase system of claim 7, each inverter of the plurality of inverters further comprising:
a connection to each of the n synchronizers, the connection for a reference sine-wave AC signal, wherein the n converter circuits are to synchronize to the reference sine-wave AC signal.

11. The self-synchronizing poly-phase system of claim 7, further comprising:
a connection to each of the n synchronizers of each of the plurality of inverters, the connection for a reference sine-wave AC signal, wherein the n converter circuits are to synchronize to the reference sine-wave AC signal.

12. The self-synchronizing poly-phase system of claim 7, each of the plurality of inverters further comprising:
at least k−1 phase shifters each to shift a single phase of AC electricity output by a corresponding converter circuit to a phase of the k phases to produce the k-phase electricity at the AC output.

13. The self-synchronizing poly-phase system of claim 7, wherein each synchronizer of the n synchronizers provides bidirectional synchronization with another synchronizer of the n synchronizers.

14. A self-synchronizing poly-phase inverter for converting direct current (DC) electricity to k-phase alternating current (AC) electricity, comprising:
one or more DC inputs for receiving DC electricity;
multiple (n) converter circuits each to convert DC electricity to single phase AC electricity, of the k-phase AC electricity, at an AC output; and
a synchronizer to operate with a non-linear characteristic, the synchronizer to drive the n converter circuits to produce all k phases of the k-phase AC electricity at a single AC frequency.

15. The self-synchronizing poly-phase inverter of claim 14, wherein the synchronizer comprises n non-linear circuits to provide the non-linear characteristic of a collapsed or non-hysteretic limit-cycle mode.

16. The self-synchronizing poly-phase inverter of claim 15, wherein the n non-linear circuits give rise to an n-phase synchronizer capable of chaotic behavior.

17. The self-synchronizing poly-phase inverter of claim 14, wherein the synchronizer provides bidirectional synchronization between the self-synchronizing inverter and at least one additional self-synchronizing inverter.

18. The self-synchronizing poly-phase inverter of claim 14, wherein the synchronizer enables synchronized load sharing between the self-synchronizing inverter and at least one additional self-synchronizing inverter.

19. The self-synchronizing poly-phase inverter of claim 14, further comprising:
a connection to connect each phase of the k-phase electricity at the first AC output of the self-synchronizing poly-phase inverter to a corresponding phase of one or more other self-synchronizing poly-phase inverters in parallel.

20. The self-synchronizing poly-phase inverter of claim 19, wherein synchronizers of the one or more other self-synchronizing poly-phase inverters are connected and the self-synchronizing poly-phase inverter and the one or more other self-synchronizing n-phase inverters collectively produce n-phases at the single AC frequency

21. The self-synchronizing poly-phase inverter of claim 14, further comprising:
at least k−1 phase shifters each to shift the single-phase AC electricity output by a corresponding converter circuit to a phase of the k phases to produce the k-phase electricity at the AC output, wherein each phase of the k phases is offset from the other k phases by 360 degrees divided by k.
